(19) United States
(12) Patent Application Publication
(10) Pub. No.: US 2005/0133315 A1
(43) Pub. Date: Jun. 23, 2005

(54) Vehicle restraint system and method

(76) Inventor: Richard K. Hoofard, Dallas, TX (US)

Correspondence Address: BAKER & HOSTETLER LLP;Washington Square, Suite 1100, 1050 Connecticut Avenue, N.W., WASHINGTON, DC, 20036, US

(21) Appl. No.: 10/742,921

(22) Filed: Dec. 23, 2003

(51) Int. Cl. B60T 1/14

(52) U.S. Cl. 188/5

(57) ABSTRACT

An embodiment in accordance with the present invention provides a vehicle restraining device that restrains a vehicle by blocking a wheel associated with the vehicle. Another embodiment of the present invention provides a method of restraining a vehicle by blocking a wheel associated with the vehicle.

### FIELD OF THE INVENTION

The present invention relates generally to a vehicle restraint and a method for restraining vehicles. More particularly, the present invention relates to a wheel stop device and method for restraining trucks and trailers at a loading dock.

### BACKGROUND OF THE INVENTION

Freight vehicles such as trucks and tractor trailers are often loaded and unloaded at a loading dock. Often at the loading dock, a dock leveler will be operated to form a bridge between the dock and the bed of the truck. Across this bridge, workers and material handling equipment such as fork trucks will pass to load or unload the vehicle. The bridge is formed by the dock leveler supported at one end by the bed of the vehicle and at the other end by the frame of the dock leveler. Movement of heavy loads starting and stopping on the bed of the vehicle creates forces that can cause the vehicle to move away from the loading dock. In addition, miscommunication between a dockworker inside, and a truck driver outside, can lead to the vehicle moving away from the loading dock. For example, if the vehicle were to pull away from the loading dock and leave the dock leveler unsupported at the end formerly supported by the vehicle bed, the dock leveler would fall. The unexpected movement of the trailer and subsequent fall of the dock leveler can have undesirable results for dockworkers on the dock leveler or in the trailer. As a result, it is important that vehicles not move away from the loading dock until the dock leveler and trailer has been cleared of workers and material handling equipment.

The need to prevent a vehicle from moving during loading and unloading operations has been addressed by a variety of different techniques. The most basic is the wheel chock, a wedge placed in front of the wheels of the truck. While simple, they are often misplaced, dislodged, or slip. Because of these deficiencies, a class of truck restraints that engage the ICC bar of the trailers has been designed and has achieved commercial success. While in most cases effective, there exist trailers with missing or damaged, or very low ICC bars, or those with rear mounted power tailgates that prevent ICC bar trailer restraints from being used effectively. Given these limitations of the ICC bar type trailer restraints, another type of truck restraint that does not rely on the ICC bar has been introduced. This type creates a barrier to the wheels of the trailer after the trailer has been positioned at the loading dock. Some of these wheel dependent systems are buried in the driveway and may be expensive to install and difficult to service. Some of these are above ground systems are configured to be driven over. Continuous driving over of the system over time can cause the systems to get damaged by vehicles while being positioned for loading and unloading. Portions of the above ground systems interfere with powered tailgates during loading and unloading.

Accordingly, it is desirable to provide a method and apparatus that will restrain a vehicle such as a truck or tractor trailer from moving away from a loading dock at an inappropriate time. The device should be easy to install and service, store out of the way of vehicles moving into position for loading and not interfere with powered tailgates during loading and unloading.

### SUMMARY OF THE INVENTION

The foregoing needs are met, to great extent, by the present invention, wherein in one aspect an apparatus is provided that in some embodiments restrains a vehicle and prevents it from moving away from a loading dock while mounting on the drive surface and storing out of the plane of the trailer.

In accordance with one embodiment of the present invention, a vehicle restraint is provided. The vehicle restraint includes a track, a carriage configured to move along the track, and a wheel block pivotally mounted to the carriage to move between non-wheel blocking position where the wheel block is substantially over or under the track, and a blocking position.

In accordance with another embodiment of the present invention, a vehicle restraint is provided. The vehicle restraint includes means for guiding, means for carrying configured to move along the guiding means, and means for blocking a wheel carried by the carrier means, wherein the means for blocking pivots between a non-blocking position wherein the wheel block is substantially over or under the track and a blocking position adjacent to a vehicle wheel to be blocked.

In accordance with another embodiment of the present invention, a method of restraining a vehicle is provided. The method includes a moving a carriage along a track to a position adjacent to a wheel to be blocked, pivoting a wheel block mounted to the carriage from a position adjacent to a wheel to a position blocking the wheel.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating truck tires parked next to a loading dock and adjacent to a wheel blocking system in accordance with the invention. The tractor trailer normally associated with the tires is not shown in order to provide more clarity to the drawing.

FIG. 2 is a perspective view of the embodiment of the invention shown in FIG. 1 where the carriage has moved out of the housing.

FIG. 3 is a perspective view of the embodiment of the invention of FIG. 1 illustrating the wheel block attached to the carriage contacting the wheel.

FIG. 4 is a perspective view of the embodiment of the invention of FIG. 1 illustrating the wheel block pivoting against the wheel as the carriage continues to move.

FIG. 5 is a perspective view illustrating the embodiment of the invention of FIG. 1 showing the wheel block in the blocking position.

FIG. 6 is a perspective view of an embodiment of the invention illustrating the carriage attached to the track and the wheel block in a non-blocking position.

FIG. 7 is a perspective view of an embodiment of the invention illustrating the carriage attached to the track and the wheel block in a blocking position.

FIG. 8 is a side view of an embodiment of the invention showing the track, the carriage attached to the track and the carriage motor.

FIG. 9 is a partial enlarged view of the portion labeled 9 in FIG. 8.

FIG. 10 is a partial enlarged view of the area labeled 10 indicated in FIG. 8.

FIG. 11 is a partial enlarged view of the area labeled 11 indicated in FIG. 8.

FIG. 12 is a perspective view of an alternate embodiment of the invention illustrating a sensor arm attached to the carriage mounted on the track.

FIG. 13. is a perspective view of an alternate embodiment of the invention illustrating the carriage mounted on the track and the wheel block in a partially engaged position.

FIG. 14 is a top view of an alternate embodiment of the invention illustrating the carriage mounted on the track carrying a wheel block and a sensor arm.

FIG. 15 is a top view of an alternate embodiment of the invention illustrating the sensor arm engaging a wheel and a wheel block in a partially engaged position with the wheel.

FIG. 16 is a perspective view illustrating an alternate embodiment of the invention illustrating the sensor arm in an engaging position.

### DETAILED DESCRIPTION

The invention will now be described with reference to the drawing figures in which like reference numerals refer to like parts throughout. An embodiment in accordance with the present invention provides a vehicle restraining device that restrains a vehicle by blocking a wheel associated with the vehicle. Another embodiment of the present invention provides a method of restraining a vehicle by blocking a wheel associated with the vehicle.

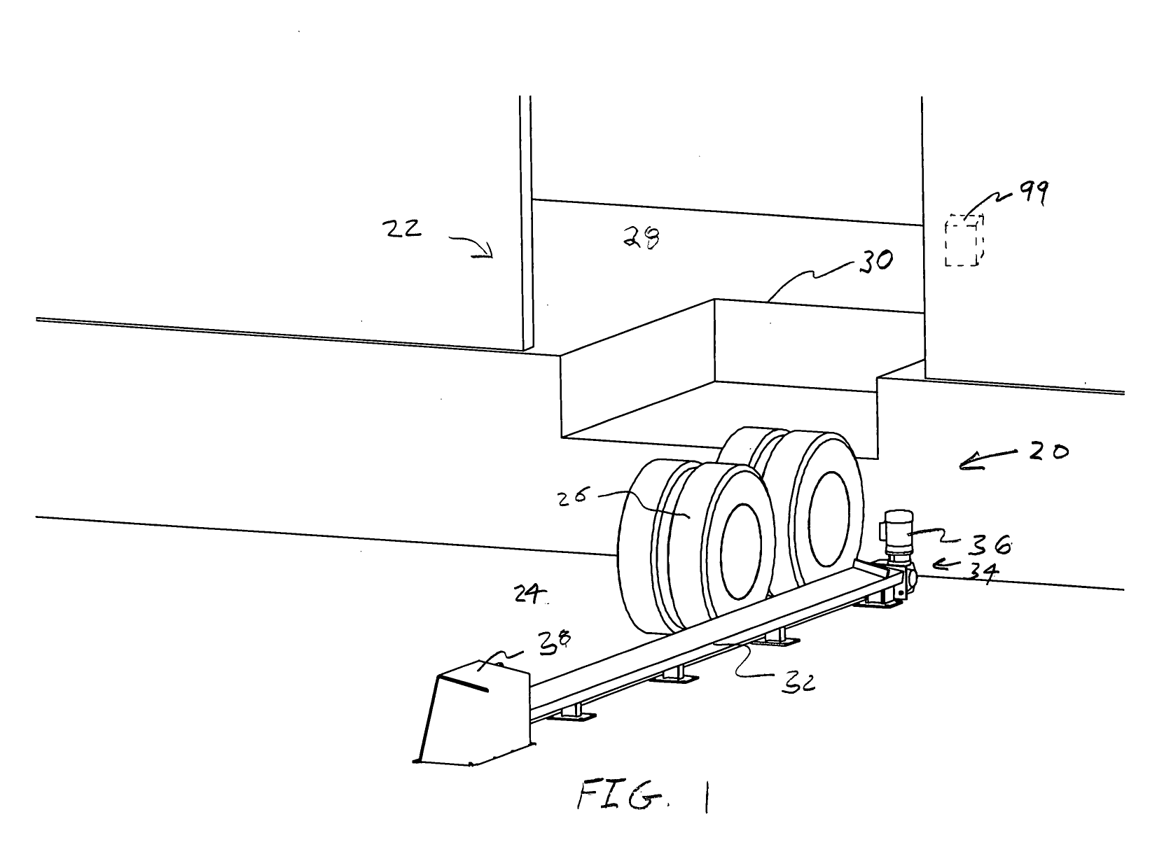

A preferred embodiment of the present inventive apparatus is illustrated in FIG. 1. A vehicle restraint system 20 is shown next to a loading dock 22. The vehicle restraint system 20 is mounted on a driveway 24. Adjacent to the vehicle restraint system 20 and located on the driveway 24 are wheels 26. The truck itself or trailer having the wheels is not shown in order to more clearly illustrate the vehicle restraint system 20 and its surrounding environment.

The loading dock 22 includes dock floor 28 and often includes a pit 30 in the dock floor 28. The pit 30 is often used for mounting a dock leveler. In operation, a vehicle is backed to the loading dock 22 and is positioned with its wheels 26 positioned adjacent to the vehicle restraint system 20 as shown in FIG. 1. The invention may be used in applications where there is no pit or dock leveler.

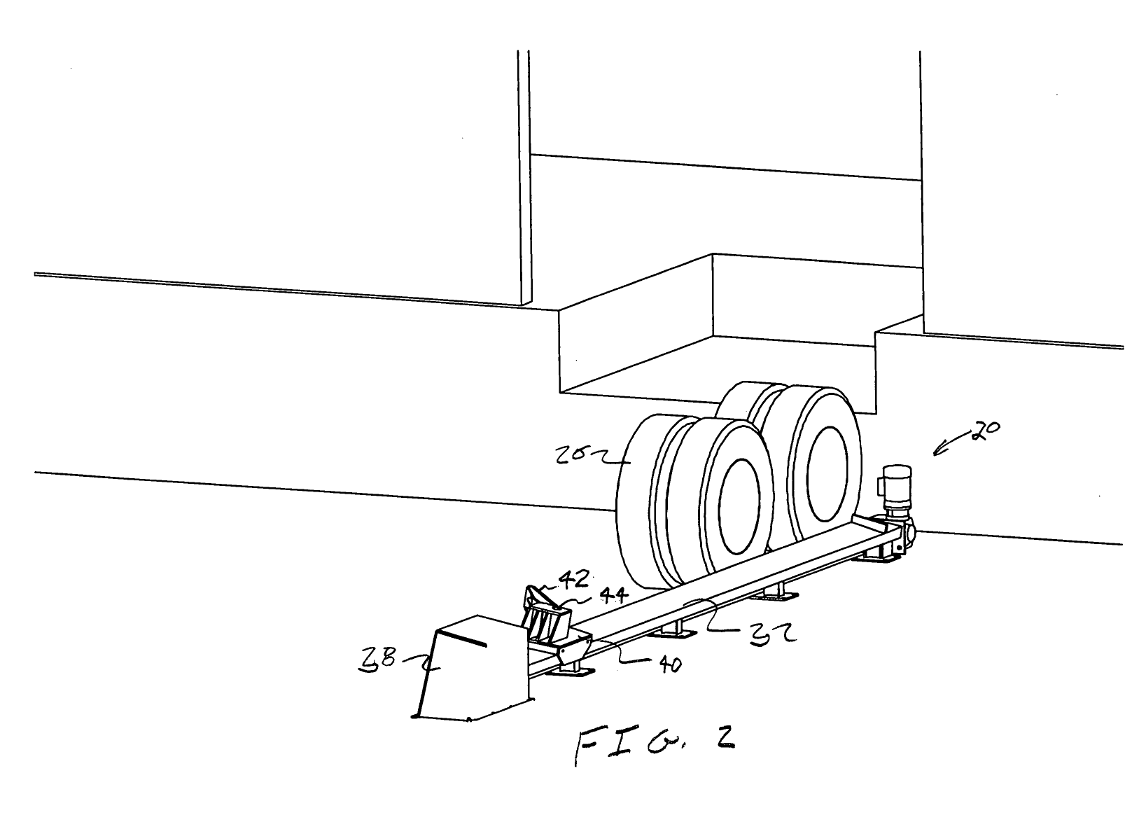

The vehicle restraint system 20 includes a track 32 mounted onto the driveway 24. At one end of the track 32 there is a drive system 34. The drive system 34 includes a drive motor 36. At the other end of the track 32 is a housing 38. When the vehicle restraint system 20 is not in use, a carriage 40 (shown in FIG. 2) is stored within the housing 38.

In operation, a trailer backs in to a loading dock 22 until the rear of the trailer is positioned against resilient bumpers mounted on the dock face. Once the vehicle wheels 26 are in position (as shown in FIG. 2), an operator will actuate a controller 99 (shown if FIG. 1) that is operatively connected to the vehicle restraint system 20, to engage the vehicle restraint system 20. The vehicle restraint system 20 will move the carriage 40 out from the housing 38. The carriage 40 will move along the track 32. The carriage 40 carries a wheel block 42. The wheel block 42 is pivotally connected to the carriage 40 with a pivot pin 44. In some embodiments of the invention, the wheel block 42 will be substantially parallel to the track 32 when the wheel block 42 is not engaged to the wheel 26. In other embodiments of the invention, the wheel block 42 will be substantially parallel to the track 32 when the carriage 40 is located in the housing 38, but as the carriage 40 moves out of the housing 38 the wheel block 42 will move to a non-parallel position with the track 32 (for example, about 10° off parallel) via a biasing member and will be in a position ready to engage the wheel 26. (The position shown in FIG. 2). While the embodiments shown illustrate the wheel block 42 located substantially above the track 32 when in the non-blocking position, other embodiments of the invention may include the wheel block 42 located below an elevated track 32 when in the non-blocking position.

In some embodiments of the invention, when the carriage 40 moves back into the housing 38, to the stored position, the wheel block will contact the side of the housing 38 and retract to a position substantially parallel to the track 32. In other embodiments of the invention, when the carriage 40 moves back into the housing 38 to the stored position, the wheel block will contact an independent feature such as a guide not part of the housing and retract to a position substantially parallel to the track 32.

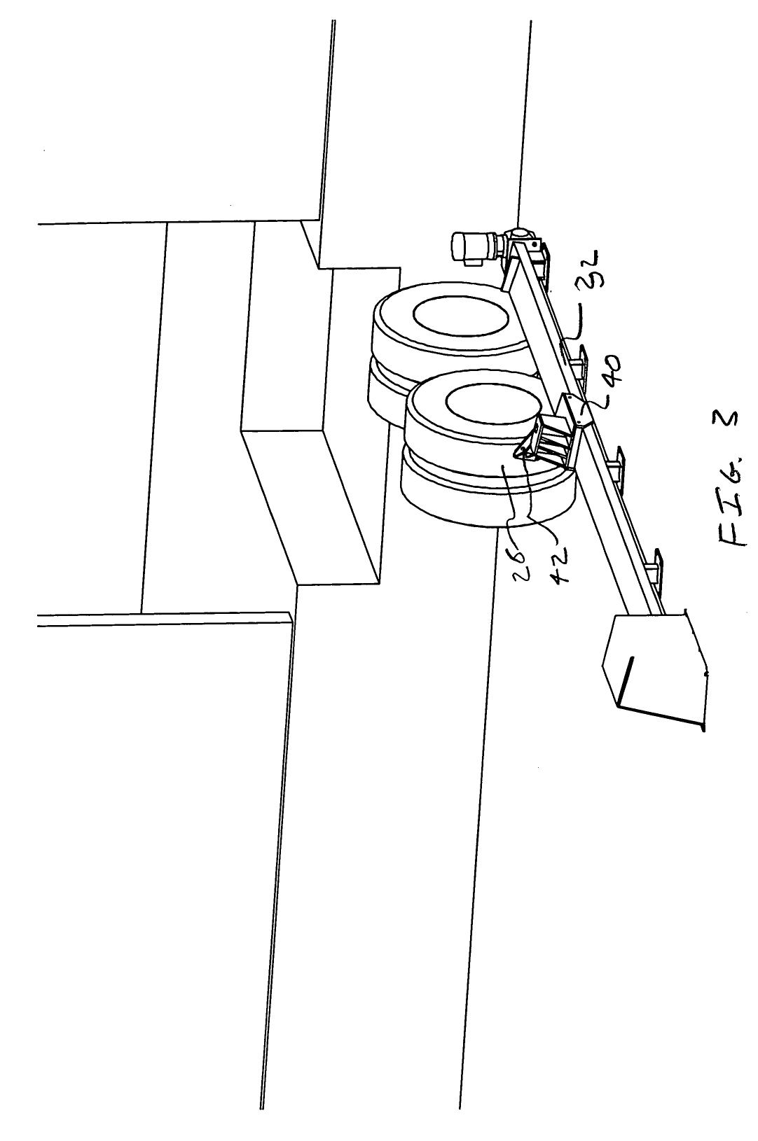

FIG. 3 illustrates the carriage 40 moving along the track 32 to a position where the wheel block 42 starts to engage the tire 26.

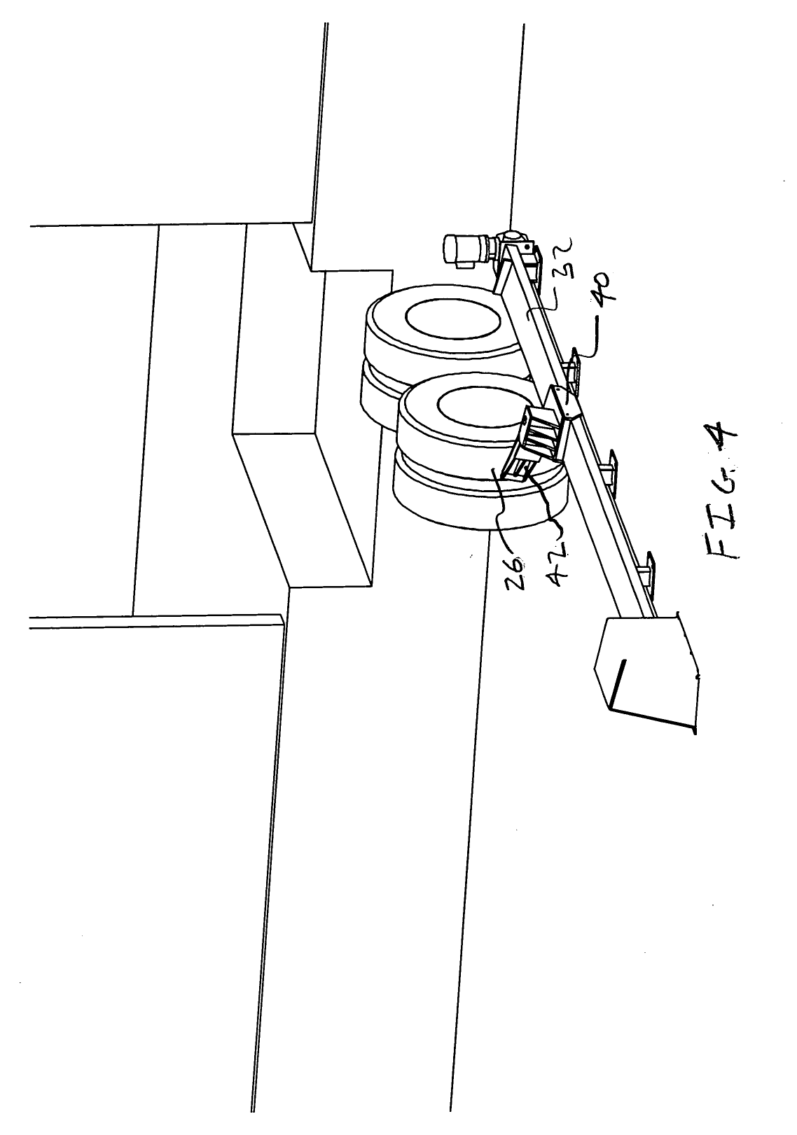

FIG. 4 illustrates the carriage 40 continuing to move along the track 32 and the wheel block 42 continues to pivot as it is engaged with the wheel 26 to a position approaching approximately perpendicular to the track 32.

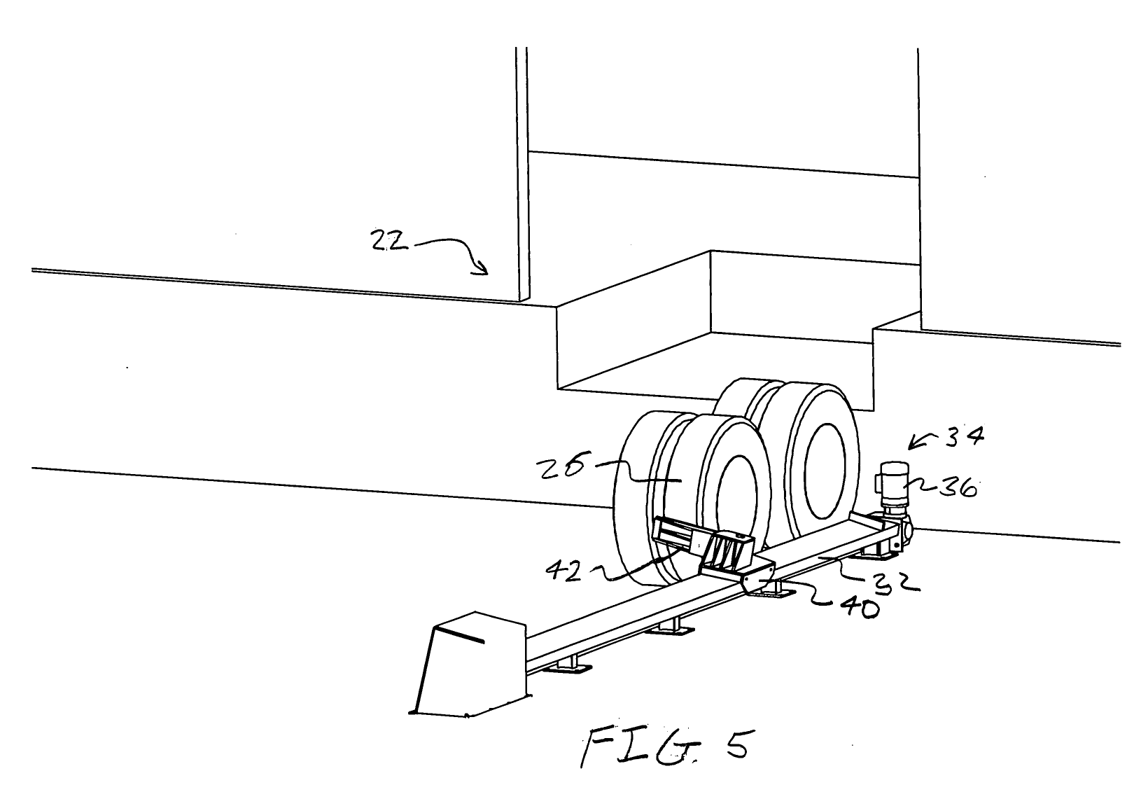

FIG. 5 illustrates the blocking position of the wheel block 42. The carriage 40 has moved along the track 32 enough to cause the wheel block 40 to pivot to its full extent against the wheel 26. In some embodiments of the invention, the carriage 40 will continue to move along the track 32 and urge the wheel block 42 against the wheel 26. The urging of the wheel block 42 against the wheel 26 will cause the carriage 40 to achieve a slight skew position with respect to the track 32.

For example, in some embodiments of the invention, the wheel block 42 will engage the wheel 26 and swing out to a position about perpendicular with the track 32. The carriage 40 will continue to travel down the track 32 until the wheel block 42 has moved a small angle beyond perpendicular with the track 32. In other embodiments of the invention the wheel block 42 will block the wheel 26 while in a position other than near perpendicular with the track 32.

A sensing device such as a limit switch or other suitable device will be activated when the wheel block 42 has achieved its full blocking position. The sensing device will send a signal to the controller 99 (shown in FIG. 1) shutting off the drive motor 36. The interface pressure between the wheel block 42 and the tire 26 will cause the carriage 40 to become slightly askew with respect to the track 32. This skewed attitude between the carriage 40 and track 32 will cause friction. The friction will aid in anchoring the carriage 40 to the track and preventing the wheel 26 from moving away from the loading dock 22 during normal loading dock operations such as loading and unloading the trailer with the wheel block 42 in the engaged position as shown in FIG. 5. In other embodiments of the invention, the drive system 34, which will be explained in more detail below, will also anchor the carriage 40 in position during normal loading dock operations with the wheel block 42 in the engaged position.

FIG. 6 is an isometric view of the track 32, carriage 40 and wheel block 42 according to a preferred embodiment of the invention. The wheel block 42 is pivotally mounted to the carriage 40. The wheel block 42 is attached to the carriage 40 by hinge pin 44 and pivots about an axis extending through the center of the hinge pin 44.

Once the wheel block 42 engages a tire 26 the carriage 40 will continue to move causing the wheel block 42 to pivot to a blocking position with respect to wheel 26. In some embodiments of the invention, the carriage 40 will continue to move along the track 32 through and past the position where the wheel block 42 contacts the tire 26, thus canting the carriage 40 with respect to the track 32.

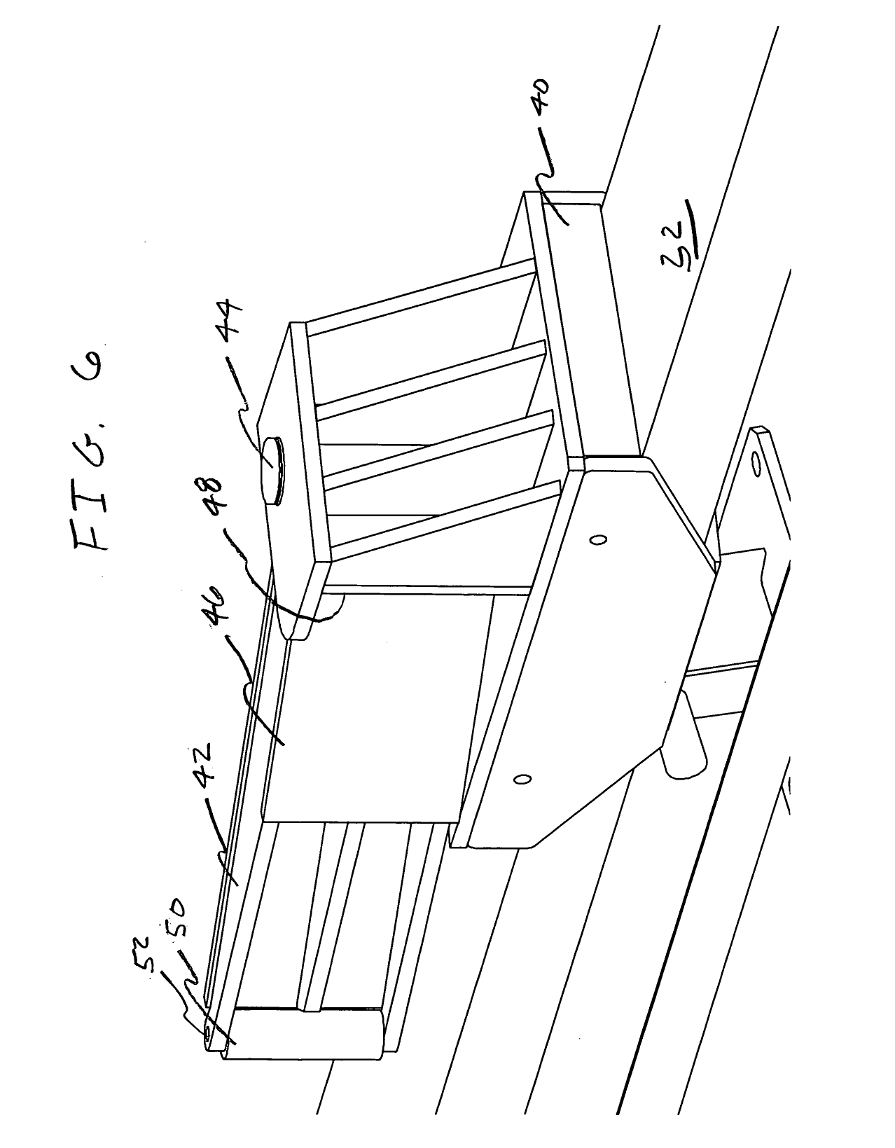

The wheel block 42 is equipped with an engaging plate 46. The engaging plate 46 will engage the stop 48 mounted on the carriage 40 when the wheel block 42 has engaged the tire 26 and swung the wheel block 42 to a blocking position as shown in FIG. 7.

To facilitate engaging the wheel block 42 with a tire 26, a roller 50 is provided on the end of the wheel block 42. The roller 50 is allowed to roll about an axle 52 and is mounted on the end of the wheel block 42. As the wheel block 42 approaches the tire 26, the roller 50 will roll along the surface of the tire 26 as the carriage 40 moves forward and the wheel block 42 begins to swing. The roller 50 can reduce friction between the wheel block 42 and the tire 26 and aid in the wheel blocking 42 engagement with the tire 26.

FIG. 7 illustrates the wheel block 42 in the blocking position. The engaging plate 46 is pressed against the stop 48. A sensing device senses that the wheel block 42 is in the blocking position and sends a signal to the controller 99 (shown in FIG. 1) which stops the drive motor 36. The sensing device is configured to send the stopping signal to the controller 99 (shown in FIG. 1) after the carriage 40 has urged the wheel block 42 against the tire 26 to the blocking position. In some embodiments of the invention, the blocking position will cause the wheel block 42 to urge against the tire 26 with some pressure. The force of the tire 26 pushing against the wheel block 42 will in some embodiments cause the carriage 40 to achieve a skewed position against the track 32. The skewed position will create friction between the carriage 40 and the track 32 thus inhibiting the carriage 40 from moving along the track 32 as previously described.

In other embodiments of the invention, the drive system 34 will hold the carriage 40 in place preventing the tire 26 from moving away from the loading dock 22 during normal loading dock operations. In other embodiments of the invention, the driving system will include additional components such as a brake mechanism that will clamp the carriage 40 to the track 32 when the carriage 40 and wheel block 42 are in a blocking position. Still other embodiments of the invention will hold the carriage 40 in place using other suitable means.

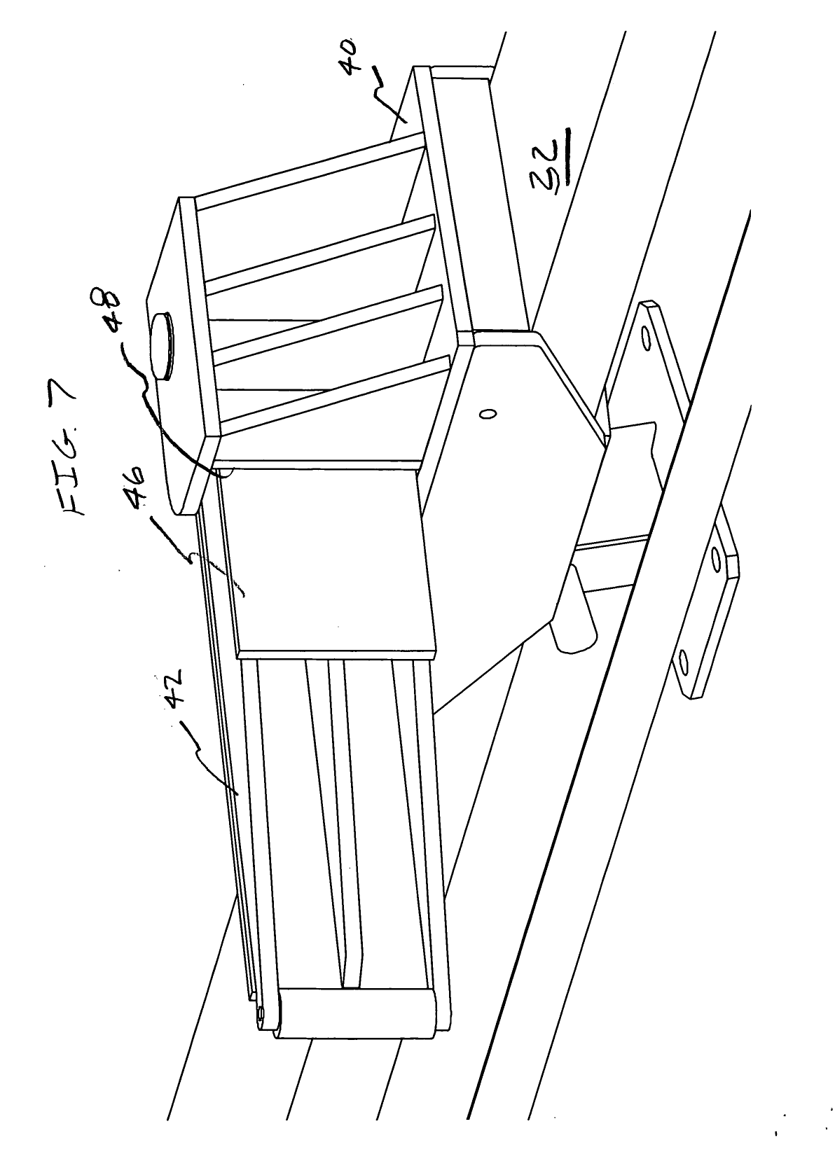

FIG. 8 is a side view of the track 32. The track 32 at periodic locations has track supports 54 supporting the track 32 on the driveway 24. At one end of the track 32 is a drive system 34. At the other end of the track 32 is the carriage 40 and the wheel block 42 in the home or rest position.

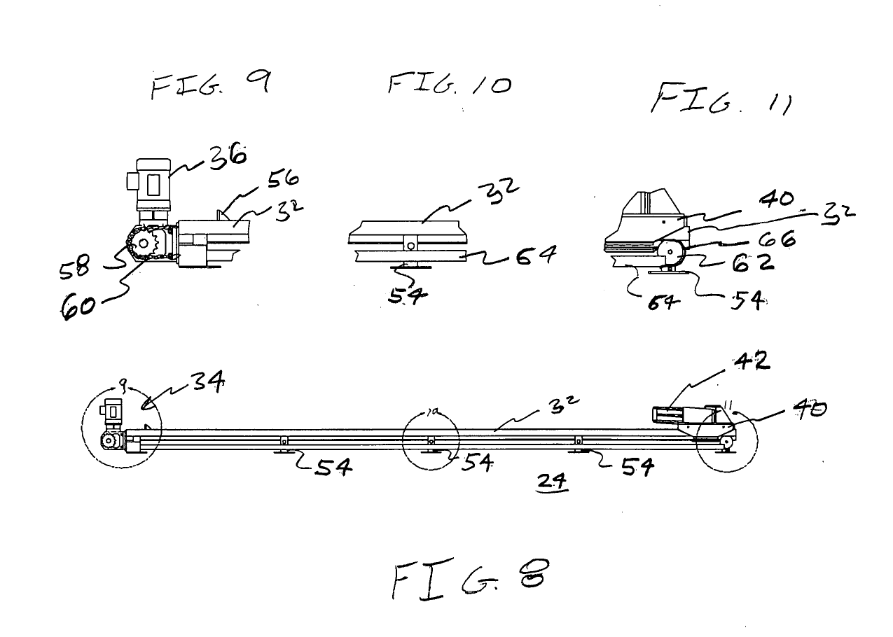

FIG. 9 is a detailed partial view of the area denoted as 9 in FIG. 8. FIG. 9 illustrates the drive motor 36 and a carriage stop 56 mounted on the track 32. The carriage stop 56 prevents the carriage 40 from obtaining an inappropriate position along the track 32 and perhaps damaging the drive system 34 or coming off the track 32. Included in the drive system 36 is a chain sprocket 58. A chain sprocket 58 drives the chain 60 which is operatively connected to the carriage 40. The chain 60 is a continuous loop. The chain 60 is looped around the sprocket 58 at one end and around the idler pulley 62 at the other end of the track 32. In some embodiments of the invention, the chain 60 is connected to a cable 66 (see FIG. 11). The cable 66 makes up part of the loop described above and is connected to the carriage 40. According to some embodiments of the invention, the sprocket 58 locks in position when the sensing device (previously described) sends a signal to the controller 99 (shown in FIG. 1) that the wheel block 42 has achieved the blocking position. Selectively preventing the rotation of sprocket 58 through suitable means will prevent the chain 60 from moving and thus will lock the carriage 40 in place on the track 32.

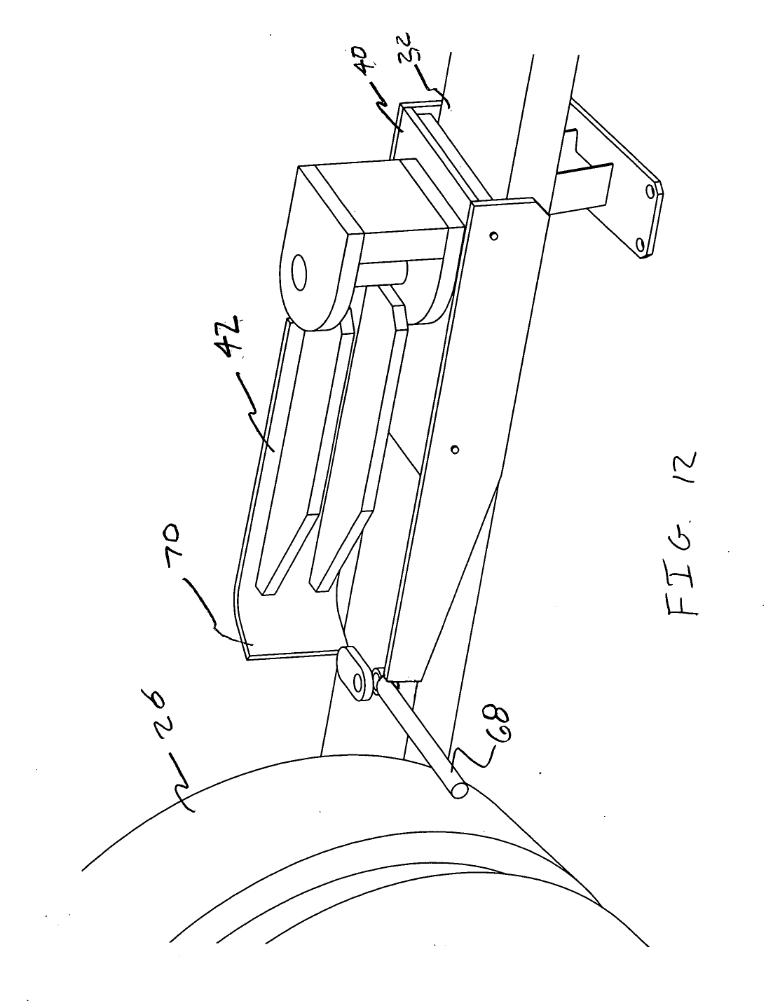

FIG. 10 is a partial detailed view of the portion marked as 10 in FIG. 8. FIG. 10 shows the track 32 and a track support 54. Also illustrated is a chain support 64. The chain support 64 supports a lower portion of the chain 60 and/or cable and also may protect the chain 60 and/or cable from debris, snow, ice or other material that may foul or damage the chain 60 and/or cable. The upper portion of the chain 60 or cable is contained within the track 32.

FIG. 11 is a detailed close-up view of the area indicated by numeral 11 in FIG. 8. FIG. 11 shows the carriage 40 mounted to the track 32. Below the track 32 is the idler pulley 62. Around the idler pulley 62 is a cable 66 which is connected to the chain 60 shown in FIG. 9. Alternate embodiments of the invention include using a chain 60 as the whole loop, or using a cable 66 to comprise part of the loop as described above. The chain support 64 is shown in FIG. 11 and provides the same protection/support function for the cable 66 as described for the chain 60. The end of the track 32 is supported by a track support 54.

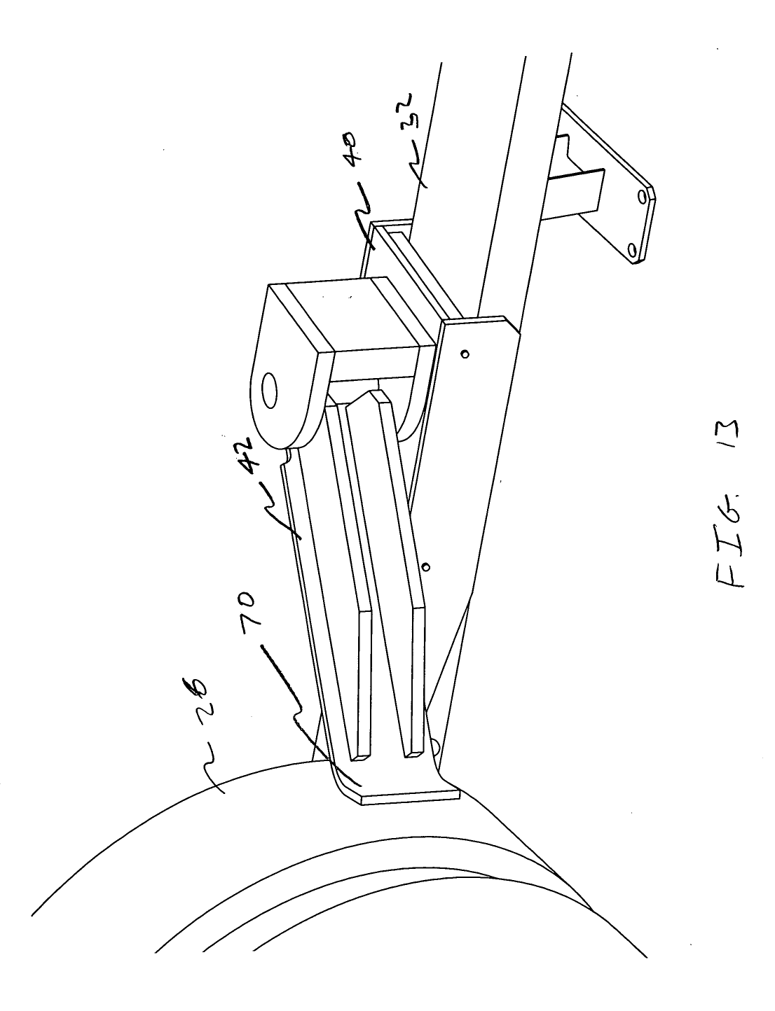

FIG. 12 is an isometric view of another embodiment of the present invention. As shown in FIG. 12, the carriage 40 rests and travels along the track 32. The wheel block 42 is mounted on the carriage 40 and is held substantially parallel to the track 32 when not in a blocking position. Other embodiments of the invention may not have the wheel block 42 be parallel to the track 32 when the wheel block 42 is not in the blocking position. A sensor arm 68 is mounted on the carriage 40. The sensor arm 68 is configured to engage a tire 26. Once the sensor arm 68 engages the tire 26 it will trigger the wheel block 42 to swing or pivot toward an operative position. At the end of the wheel block 42 is a feature 70 which is configured to engage the tire 26 and cause the wheel block 42 to pivot toward a blocking position without damaging the tire 26. The feature 70 may be a bent portion of the wheel block 42 as shown, or a roller 50 as previously described.

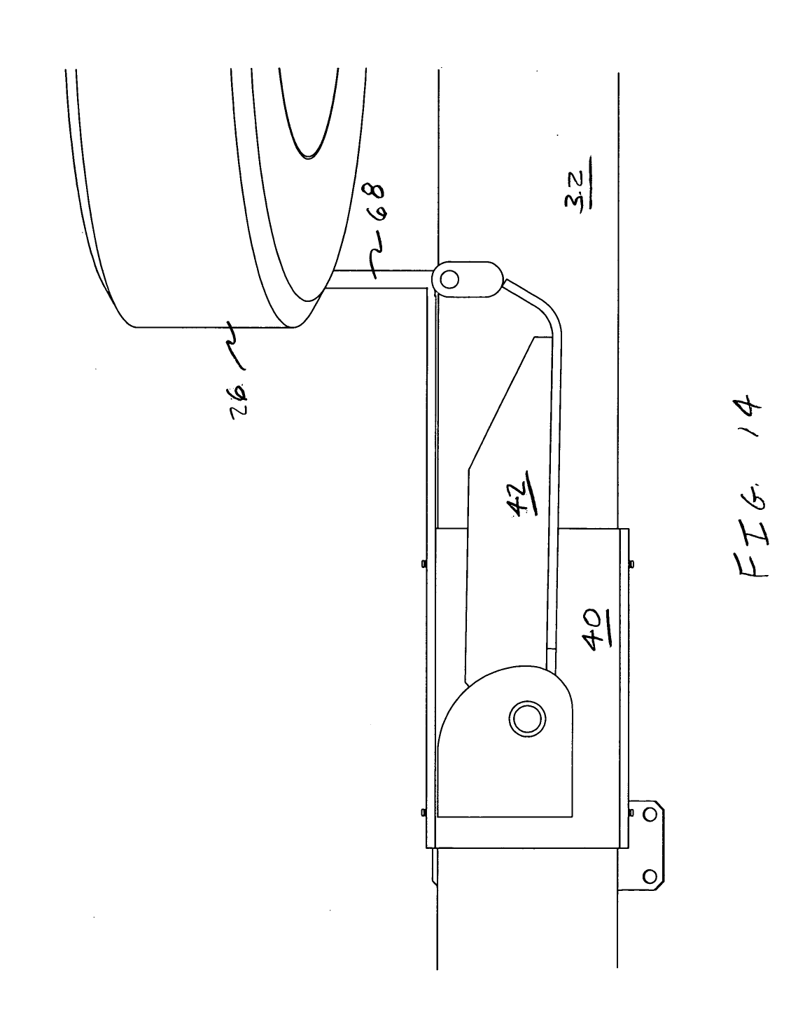

FIG. 13 illustrates the wheel block 42 engaging the wheel 26 as the carriage 40 moves along the track 32. The end feature 70 has engaged the tire 26 and is pivoting the wheel block 42 to the engaged position.

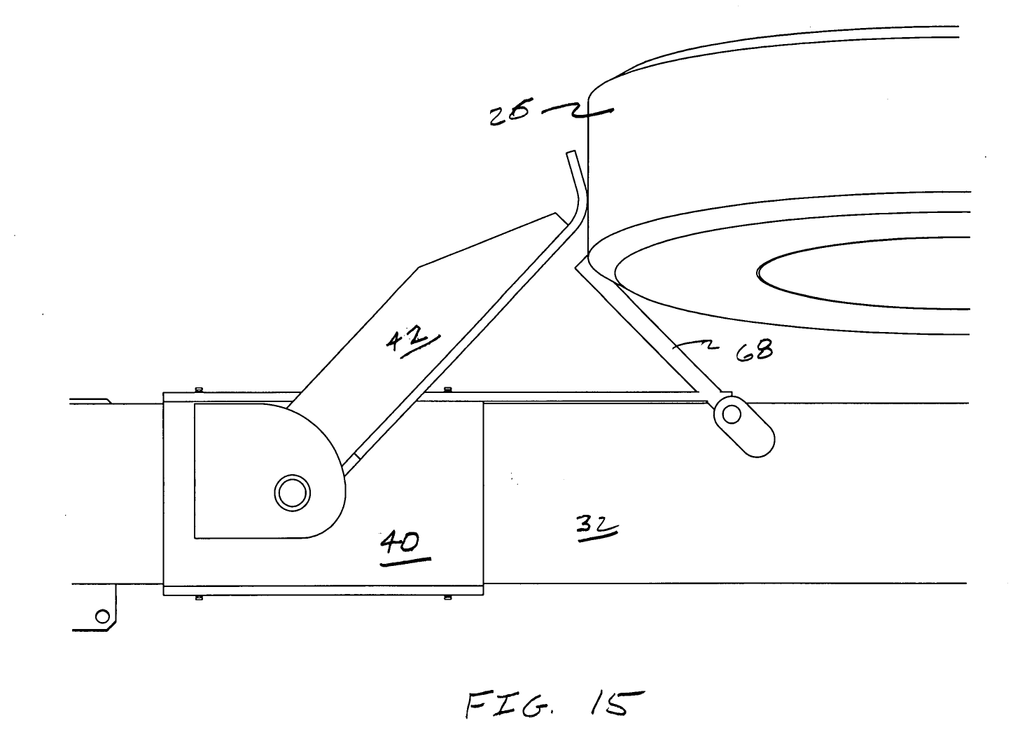

FIG. 14 is a top view of the embodiment shown in FIGS. 12 and 13. A sensor arm 68 is about to engage the tire 26. The wheel block 42 is mounted on the carriage 40 and the wheel block 42 is in a substantially parallel position with respect to the track 32 when not in an engaged position.

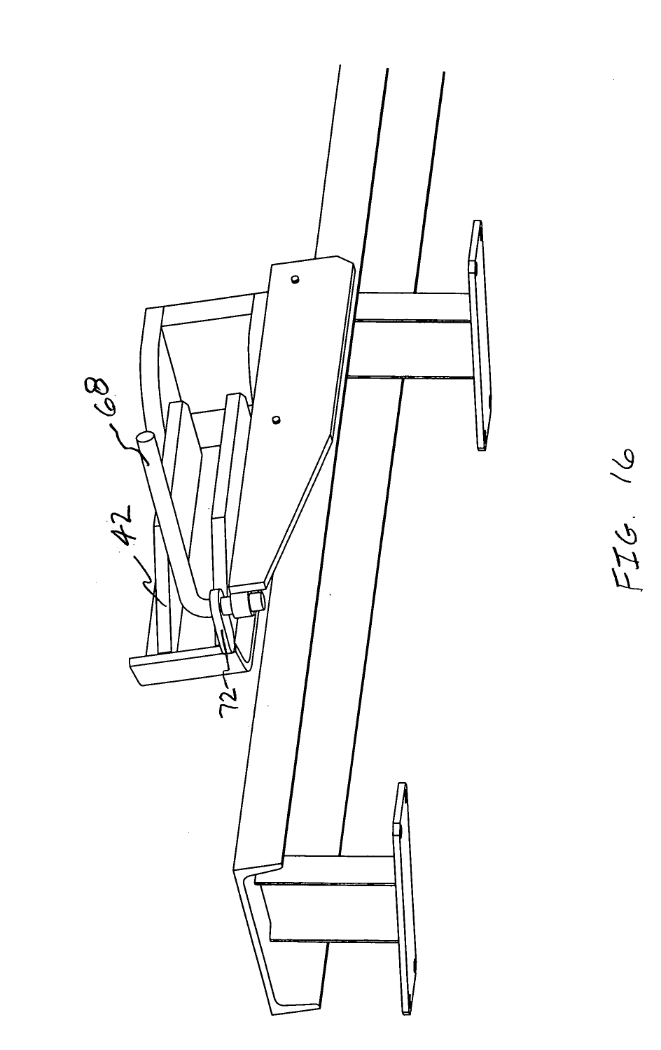

FIG. 15 illustrates the sensor arm 68 engaging the tire 26. The sensor arm 68 is starting to pivot on the carriage 40. The pivoting action of the sensor arm 68 triggers a release mechanism operatively connected with the wheel block 42 causing the wheel block 42 to be released from its substantially parallel position to the track 32 and start to move towards a blocking position. A biasing member such as a spring pushes the wheel block 42 to a partially blocking position when the sensor arm 68 triggers the wheel block 42 release by the sensor arm 68 engaging a tire 26.

FIG. 16 illustrates the sensor arm 68 attached to the carriage 40 by a sensor arm bracket 72. Other embodiments of the invention may attach the sensor arm 68 by other suitable means.

In some embodiments of the invention, where a sensor arm 68 is used, the sensor arm 68 and the wheel block 42 are substantially parallel to the track 32 when the carriage 40 is in the stored position within the housing 38. As the carriage 46 moves out of the housing 38 a biasing member such as a spring will move the sensor arm 68 to the engaging position ready to engage the tire 26 (a position extending out from the track 32).

The wheel block 42 is biased to move to an engaging position (the position shown in FIG. 12). Alternatively, the wheel block 42 may remain in a non-engaging position until the sensor arm 68 triggers a release to allow a biasing member such as a spring to move the wheel block 42 to a wheel engaging position (the position shown in FIG. 15).

When the carriage 40 is moving back to the stored position, the wheel block 42 and sensor arm 68 will contact the housing 38. As the carriage 40 moves into the housing 38, the contact with the housing will cause the wheel block 42 and sensor arm 68 to pivot to their stored positions (approximately parallel with the track 32 in the embodiment shown, but not necessarily parallel in all embodiments of the invention).

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A vehicle restraint comprising:
a track;
a carriage configured to move along the track; and
a wheel block pivotally mounted to the carriage to move between a non-wheel blocking position where the wheel block is substantially over or under the track, and a blocking position.

2. The vehicle restraint of claim 1, wherein the pivoting motion of the wheel block is substantially limited to pivoting in a plane horizontal to the track.

3. The vehicle restraint of claim 1, further comprising a wheel block stop mounted on the carriage configured to limit the pivoting motion of the wheel block.

4. The vehicle restraint of claim 1, further comprising an actuator operatively connected to the carriage and configured to move the carriage along the track.

5. The vehicle restraint of claim 1, further comprising a housing located at one end of the track for containing the carriage when the carriage is not in use.

6. The vehicle restraint of claim 5, wherein at least a portion of the housing is configured to cause the wheel block to move to the non-blocking position as the carriage moves into the housing to a rest position.

7. The vehicle restraint of claim 1, wherein the wheel block is pivotally attached to the carriage at one of: along a centerline associated with the carriage and between the centerline and a side of the carriage near a wheel to be blocked.

8. The vehicle restraint of claim 1, further comprising a spring biasing the wheel block to the blocking position.

9. The vehicle restraint of claim 8, further comprising a release latch operatively connected to the wheel block to hold the wheel block in the non-blocking position.

10. The vehicle restraint of claim 1, further comprising a sensor attached to the carriage and operatively connected to the wheel block and configured to cause the wheel block to pivot from the non-blocking position to the blocking position when the sensor contacts a tire to be blocked.

11. The vehicle restraint of claim 10, wherein the sensor includes at least in part, a trigger arm extending from the carriage.

12. The vehicle restraint of claim 10, wherein the sensor includes at least in part a tip portion of the wheel block.

13. The vehicle restraint of claim 10, wherein the sensor includes a roller.

14. The vehicle restraint of claim 10, wherein the sensor is configured to retract to a position located substantially over the track.

15. The vehicle restraint of claim 1, wherein the carriage is configured to stop along the track when the wheel block is in the blocking position.

16. The vehicle restraint of claim 15, wherein the predetermined position is at a position where the wheel block is in the blocking position and the wheel block is snugly contacting a wheel.

17. The vehicle restraint of claim 1, further comprising a controller configured to control the movement of the carriage along the track.

18. The vehicle restraint of claim 1, wherein the carriage stops once the carriage has a achieved a rest position.

19. The vehicle restraint of claim 1, further comprising a spring biasing the wheel block to a position where it will contact a vehicle wheel.

20. The vehicle restraint of claim 1, wherein a feature is configured to cause the wheel block to move to the non-blocking position as the carriage moves into the housing to a rest position.

21. A vehicle restraint comprising:
means for guiding;
means for carrying configured to move along the guiding means; and
means for blocking a wheel carried by the carrying means, wherein the means for blocking pivots between blocking position wherein the means for blocking is located substantially above or below the guiding means and a non-blocking position adjacent to a vehicle wheel to be blocked.

22. A method of restraining a vehicle comprising:
moving a carriage along a track to a position adjacent to a wheel to be blocked; and
pivoting a wheel block mounted to the carriage from a position located substantially above or below the track to a position blocking the wheel.

23. The method of claim 22, further comprising triggering the wheel block to pivot by contacting the wheel with a sensor.

24. The method of claim 23, further comprising pivoting the sensor from an inoperative position to an operative position.

25. The method of claim 23, further comprising pivoting at least one of the sensor and the wheel block with at least part of a housing with moving the carriage to a rest position contained at least in part by the housing.

26. The method of claim 22, further comprising arming the wheel block by contacting the wheel with a sensor and triggering the wheel block to pivot to a blocking position by continuing to move the carriage.

27. The method of claim 22, further comprising operating the carriage to move along the track with a controller.

28. The method of claim 22, further comprising locking the carriage to a predetermined position.

29. The method of claim 22, further comprising pivoting to an operative position by moving the sensor out of a housing.

30. The method of claim 23, further comprising pivoting at least one of the sensor and the wheel block with a feature with moving the carriage to a rest position contained at least in part by the housing.
